(19) United States
(12) Patent Application Publication
(10) Pub. No.: US 2006/0147986 A1
(43) Pub. Date: Jul. 6, 2006

(54) Gene and protein libraries and methods relating thereto

(75) Inventors: Anna Victoria Hine, Kiddeminster (GB); Jane Leonie Morgan, Whitchurch (GB); Albert Francis Santos, Cardiff (GB); David Palfrey, Nuneaton (GB)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: Amersham Biosciences UK Limited

(21) Appl. No.: 11/369,726

(22) Filed: Mar. 7, 2006

Related U.S. Application Data
(62) Division of application No. 09/787,228, filed on Jul. 19, 2001.

(30) Foreign Application Priority Data
Sep. 14, 1998 (EP) 98307434.5

(51) Int. Cl. C40B 40/08; C40B 40/10

(52) U.S. Cl. 435/6

(57) ABSTRACT

A set of libraries of proteins, which proteins are capable of specific binding interactions by virtue of amino acid residues at two or more determined positions including a first determined position and one or more other determined positions, which set of libraries consists of: a) 6 to 20 libraries in which each library has one or several but less than 20 amino acid residues at the said first determined position and is randomised at the said one or more other determined positions, the arrangement being such that interaction of the 6 to 20 libraries with a specific binding partner identifies an amino acid residue at the said first determined position that takes part in the specific binding interaction, and b) 6 to 20 libraries of corresponding design for each of the said one or more other determined positions. A set of libraries of genes which code for the proteins. A method of identifying a protein which interacts with a specific binding partner, which method comprises incubating the protein with each library of the set of libraries of proteins, observing specific binding interactions with certain libraries of the set, and using the observations to identify a protein which interacts with the specific binding partner. A method of making a library of randomised genes.

### CROSS REFERENCE TO RELATED APPLICATIONS

This application is a divisional of U.S. patent application Ser. No. 09/787,228 filed Jul. 19, 2001, which is a filing under 35 U.S.C. § 371 and claims priority to international patent application number PCT/GB99/03081 filed Sep. 14, 1999, which claims priority to European patent application number 98307434.5 filed Sep. 14, 1998; the disclosures of which are incorporated herein by reference in their entireties.

### BACKGROUND OF THE INVENTION

Naturally occurring proteins are capable of specific binding interactions with other proteins and other molecules. It is well known that such proteins can be used as scaffolds and specific amino acid residues changed in order to improve binding properties. The changes required can be determined by combinatorial chemistry means. The subject is reviewed by Per-Ake Nygren and Mathias Uhlen in Curr. Opin. Struct. Biol. (1997) 7, 463-469, who list cyclic peptides, immunoglobulin-like scaffolds, bacterial receptors, DNA-binding proteins and protease inhibitors as examples of protein scaffolds. The authors conclude that, starting from a suitable protein domain, the use of a combinatorial approach coupled with powerful selection or screening strategies can be used to obtain novel proteins capable of binding a desired target molecule. But the selection or screening strategies can be difficult. It is this problem that is addressed by the present invention.

Zinc fingers are examples of protein scaffolds of the kind described. Zinc fingers are protein motifs (“mini-domains”) which interact with double-stranded DNA (some also bind RNA). This interaction is dependent on DNA sequence, thus the interaction is termed to be sequence-specific. The interaction between the zinc finger and its target DNA sequence is modular: one zinc finger recognises three bases of DNA. Basic rules concerning the interaction were determined early on by structural studies (both X-ray crystallography and NMR spectroscopy) of zinc finger-DNA complexes. In essence, three residues (amino acids) within the zinc finger make base-specific contacts with the DNA. These three residues differ greatly between different zinc fingers, allowing a limited repertoire of different DNA sequences to be recognised. Early mutagenesis experiments determined that if these variable residues are changed, a different DNA sequence may be recognised. (A fourth residue sometimes contributes to DNA recognition, but this residue is well-conserved between different zinc finger proteins). In practice then, the zinc finger may be viewed as a molecular scaffold, which orientates the three variable residues suitably to enable them to make base-specific contacts with the DNA.

It would be most advantageous to have available a zinc finger to bind each trinucleotide (3 bases) of dsDNA. Initial attempts to achieve this goal centred on the structure-based design of novel zinc finger proteins. Since 1994 however, several groups have employed combinatorial libraries of zinc finger proteins and/or target DNA sequences to identify novel zinc fingers which bind to the required DNA sequences

One such technique has been developed by Choo and Klug and is described in WO 96/06166 and in PNAS, 91, 11163-11167 and 11168-11172 (1994). A single library of zinc finger genes was constructed. The library was based on a naturally occurring zinc finger protein, Zif 268, which contains three zinc fingers. Only the central finger was randomised at seven positions. The library of genes was cloned as a fusion to the fd phage gene pIII. When expressed, a library of bacteriophage resulted, in which each bacteriophage displayed a randomised zinc finger protein on its surface. In a first stage assay, this library was incubated with a target DNA molecule, and individual clones that bound to the target were purified and sequenced. In a second stage assay, each of those clones selected was incubated with a variety of related DNA sequences in order to further investigate its binding properties. The technique is subject to some inherent disadvantages:
Deconvolution is not addressed—purification is inherent in the method. The assay results in a pool of a bacteriophage. For identification purposes, each member of that pool must be cultured independently and its DNA sequenced.
The experimental end point is determined empirically. While the assay is in progress, it is impossible to determine the number of different phage binding to the target DNA. The end point is therefore determined empirically e.g. by 15 washes. Any zinc finger which binds to the target DNA with sufficient strength to withstand these washes is selected, and a pool of zinc fingers results. There is no in-built mechanism to determine relative binding strengths of zinc fingers within this selected pool; hence the need for a second stage assay.
Library size. Constructing a library of the size required is technically difficult—indeed, the authors largest library is 200 times smaller than that theoretically required. When expressed therefore, several zinc finger proteins may be omitted.

### BRIEF SUMMARY OF THE INVENTION

The present invention addresses these shortcomings.

Zinc fingers are small protein motifs. They form parts of larger proteins, but perform their specific function within those proteins. Zinc fingers exist in tandem arrays: proteins containing between 2 and 37 different zinc fingers have been identified.

In two dimensions, a single zinc finger appears as follows (SEQ ID NO: 3):

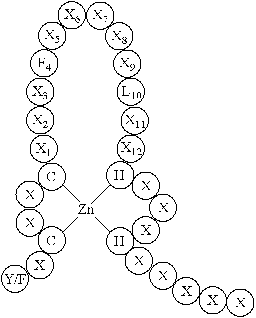

In this diagram, each circle represents a single amino acid residue.

The zinc finger is so stable that its structure is unaffected by the replacement of virtually all residues marked “X” with alanine (Michael et al, PNAS 89, 4796-4800, 1992). Spaced correctly (as above) the following requirements are all that are necessary for the formation of a zinc finger:
The 2 cysteine (C) residues
The 2 histidine (H) residues
The zinc ion (Zn), which is co-ordinated (bound) by the C and H residues
Three hydrophobic residues: tyrosine/phenylalanine (Y/F); phenylalanine (F₄); leucine (L₁₀).

Zinc fingers bind to nucleic acids—either DNA or RNA. In nature, zinc fingers usually form part of transcription factors, but in the laboratory, it is possible to work with them independently from the rest of these proteins. The zinc finger exemplified herein binds to double-stranded DNA. One zinc finger binds to three bases of DNA (a trinucleotide).

Several zinc fingers are usually linked in tandem. Most frequently, three zinc fingers interact with successive trinucleotides, which means that altogether, the three zinc fingers will interact with (recognise) a specific 9 base pair (bp) sequence of DNA. Each zinc finger will recognise a specific trinucleotide. However, nature has only provided a limited repertoire of zinc fingers, so the number of 9 base pair sequences which can be recognised is very limited.

The mechanism of DNA recognition is sequence-specific and surprisingly simple. Three residues (amino acids) within the zinc finger make contacts (hydrogen bonds or Van de Waal's interactions, for example) with three bases of DNA. Most of these contacts are with one strand of the DNA.

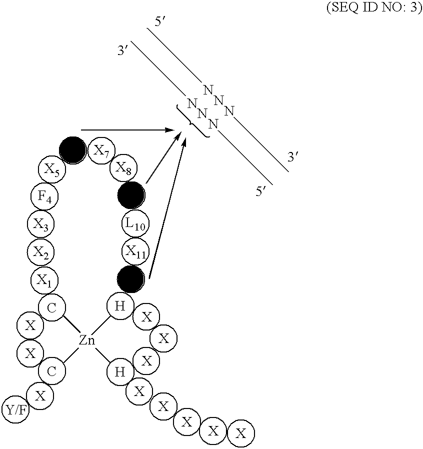

Many experiments have shown that if the three interacting residues (here named α, β and γ) are changed, the resulting zinc finger will recognise a different sequence of DNA. Moreover, if a library of zinc finger proteins is made in which α, β and γ are randomised, new zinc finger proteins may be identified by screening the library with a specific sequence of DNA.

There are 64 possible trinucleotides:

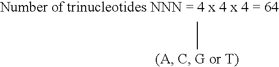

Therefore, 64 different zinc finger proteins, each of which binds optimally to one trinucleotide would represent: a complete zinc finger code. A problem (addressed by this invention) is to develop such a code.

This invention involves applying the principles of combinatorial chemistry to the problem. The key to any combinatorial system (whether biological, chemical or any other system) is deconvolution: the identification of an active substituent from within a mixture. The key to discovering an optimal zinc finger for each trinucleotide is to identify the optimum combinations of residues α, β and γ. There will be an optimum combination of α, β and γ for each trinucleotide. By using multiple libraries of zinc fingers, with highly controlled overlap between the libraries, deconvolution can be achieved without purification.

### BRIEF DESCRIPTION OF THE DRAWINGS

FIG. 1 demonstrates colorimetric detection of biotinylated DNA by a GST ZF fusion protein directly attached to a microtiter plate.

FIG. 2 demonstrates scintillation-based detection of radiolabelled DNA by a GST ZF fusion protein directly attached to a microtiter plate.

FIG. 3 demonstrates scintillation-based detection of radiolabelled DNA by a GST ZF fusion protein attached to a microtiter plate through antibody-based attachment.

### DETAILED DESCRIPTION OF THE INVENTION

In one aspect the invention provides a set of libraries of genes which code for proteins which are capable of specific binding interactions by virtue of amino acid residues at two or more determined positions including a first determined position and one or more other determined positions, which set of libraries consists of:

a) 6 to 20 libraries in which each library has a triplet that codes for one or several but less than 20 amino acids at the said first determined position, and is randomised at the triplet or triplets coding for the said one or more other determined positions, the arrangement being such that interactions of the proteins coded for by the said 6 to 20 libraries with a specific binding partner identifies a triplet that codes for an amino acid at the said first determined position that takes part in the specific binding interaction, and

b) 6 to 20 libraries of corresponding design for each of the said one or more other determined positions.

In another aspect the invention provides a method of constructing randomised gene libraries in which the number of genes is the same as the number of encoded proteins and which contain no termination codons at the predetermined positions of randomisation, the method comprising the steps of:

a) providing a template oligonucleotide which is fully randomised at one or more predetermined codon positions;

b) for each determined codon position providing a pool of selection oligonucleotides, wherein each member of said pool contains a different codon selected from the group consisting of AAA, AAC, ACC, AGC, ATG, ATT, CAG, CAT, CCG, CGC, CTG, GAA, GAT, GCG, GGC, GTG, TAT, TGG, TGC, TTT.

At the predetermined codon position;

c) selecting one or more selection oligonucleotides from each pool in order to encode the required gene or library;

d) allowing the selected selection oligonucleotides from each pool to hybridise with the template oligonucleotide;

e) forming one or more constructs by ligating the hybridised selection oligonucleotides together;

f) removing a region from a gene of interest corresponding to the hybridised product from step e);

g) forming a gene or library of genes by ligating the products from step e) into said gene of interest wherein the said gene of interest is contained within a suitable expression vector. A preferred method of selecting one or more selection oligonucleotides from each pool in order to encode the required gene or library at step c), is to select the selection oligonucleotides according to randomisation strategy B, described herein. A method of producing proteins encoded by these randomised gene libraries is also provided by the invention and comprises the steps of:

a) transforming a suitable host cell with a gene or gene library construct;

b) expressing the genes to form proteins;

c) purifying the proteins.

Suitable host cells, gene expression methods and purification protocols for carrying out this method are known in the art.

In another aspect the invention provides a set of libraries of proteins, which proteins are capable of specific binding interactions by virtue of amino acid residues at two or more determined positions including a first determined position and one or more other determined positions, which set of libraries consists of:

a) 6 to 20 libraries in which each library has one or several but less than 20 amino acid residues at the said first determined position and is randomised at the said one or more other determined positions, the arrangement being such that interaction of the 6 to 20 libraries with a specific binding partner identifies an amino acid residue at the said first determined position that takes part in the specific binding interaction, and

b) 6 to 20 libraries of corresponding design for each of the said one or more other determined positions.

In another aspect the invention provides a method of identifying a protein which interacts with a specific binding partner, which method comprises providing a set of libraries of proteins as defined, incubating the specific binding partner with each library of the set, observing specific binding interactions with certain libraries of the set, and using the observations to identify a protein which interacts with the specific binding partner. Preferably, as discussed in more detail below, this method may be performed using radiometric or non-radiometric detection means, for example scintillation detection, luminescence, for example fluorescence, detection, calorimetric detection, or imaging by methods known in the art.

A library of compounds (e.g. genes or proteins) consists of a plurality of compounds which are all different but which have some characteristic in common. The compounds of the library may be presented either separate or together, in solution or solid phase. In a set of libraries, the compounds of any one library have some characteristic in common but which differentiates them from the compound of each other library of the set.

A specific binding interaction of a protein with another molecule (the specific binding partner) is an interaction mediated by a specified amino acid residue at one or more usually several positions in the protein molecule. The specific binding partner is usually though not necessarily a polymeric molecule, e.g. a nucleic acid (DNA or RNA) or another protein.

In relation to proteins, the statement that a library is randomised at a determined position is herein used to mean that the library contains a random mixture of all or almost all possible amino acid residues. We say “almost all” because there might be a special reason for omitting one residue e.g. Cys, or a few amino acid residues. In relation to genes, the statement that a triplet is randomised is herein used to indicate a triplet NNN (where N is any nucleotide) or a triplet that is capable of coding for all or almost all the amino acids.

The term protein is herein used to encompass any chain of two or more amino acid residues.

The term polynucleotide is herein used to encompass any chain of three or more nucleotide residues, single-stranded or double-stranded DNA or RNA.

The experimental section below describes a set of libraries of zinc finger genes which code for a set of libraries of zinc finger proteins, which are used to identify specific zinc fingers which interact with specific polynucleotides. But the invention is more broadly applicable. It is in principle possible to make a set of libraries of any protein which undergoes a specific binding interaction, using that protein as a scaffold to vary specific amino acid residues. It is in principle possible to make a set of libraries of genes coding for such a set of protein libraries. And it is possible to use such a set of protein libraries to investigate any specific binding interaction, e.g. where the specific binding partner is a polynucleotide or another protein or a different molecule. It may be noted that zinc fingers may be capable of undergoing specific binding interactions, not only with polynucleotides, but also with other proteins.

It is convenient to control the overlap between libraries of a set of protein libraries by controlling the DNA sequences of the genes which code for the proteins. Thus, to make a library of zinc finger proteins, a library of zinc finger genes is first made. For convenience in relation to what follows we quote the genetic code which relates the identities of codons to the amino acids which they specify.

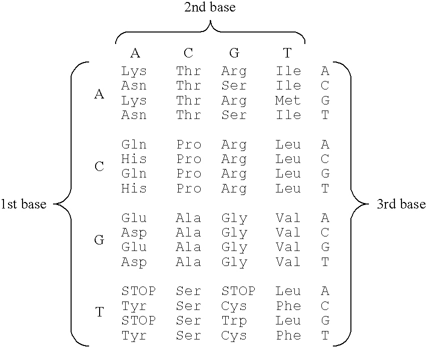

Thus for example a codon with multiple degeneracy, e.g. ANN comprises 16 different triplets and codes for seven different amino acids namely Lys, Asn, Thr, Arg, Ser, Ile and Met.

While it is possible in principle to use as few as six libraries of genes to identify a particular amino acid residue, it is in practice convenient to use twelve such libraries in groups of four, wherein libraries 1 to 4 identify the first nucleotide of a triplet, libraries 5 to 8 identify the second nucleotide of the triplet, and libraries 9 to 12 identify the third nucleotide of the triplet which codes for the amino acid. In this arrangement it is preferable that only one of libraries 1 to 4 (and correspondingly only one of libraries 5 to 8 and only one of libraries 9 to 12) codes for any particular amino acid. These considerations give rise to various possible sets of 12 libraries of which one is shown in the following Table 1.

TABLE 1

| Library | Residue | Codon | Amino Acids Specified |
|---|---|---|---|
| 1 | α | A [symbol] N | Lys Asn Thr Ile Met |
| 2 | α | C [symbol] N | Gln His Pro Arg |
| 3 | α | GNN | Au Asp Ala Gly Val |
| 4 | α | TNN | Tyr Ser Cys Trp Leu Phe |
| 5 | α | NAN | Lys Asn Gln His Glu Asp Tyr |
| 6 | α | NCN | Thr Pro Ala Ser |
| 7 | α | [symbol] GN | Arg Gly Cys Trp |
| 8 | α | [symbol] TTN | Ile Met Leu Val Phe |
| 9 | α | [symbol] [symbol] G | Lys Thr Met Gln Pro Leu Glu Ala Val |
| 10 | α | TGG | Trp |
| 11 | α | N [symbol] C | Asn Ser His Arg Asp Gly Tyr Cys |
| 12 | α | [symbol] TTC | Ile Phe |

Note that any given amino acid appears only once in any set of 4 libraries.

Similar randomisation can now be applied to all three positions: α, β and γ of zinc finger proteins, to generate libraries 1-36. In libraries 1-12, the randomisation of residue α is controlled (in these libraries, residues β and γ are fully randomised—they are specified by the codon NNN). Similarly, libraries 13-24 control the randomisation of position β, libraries 25-36 control the randomisation of residue γ).

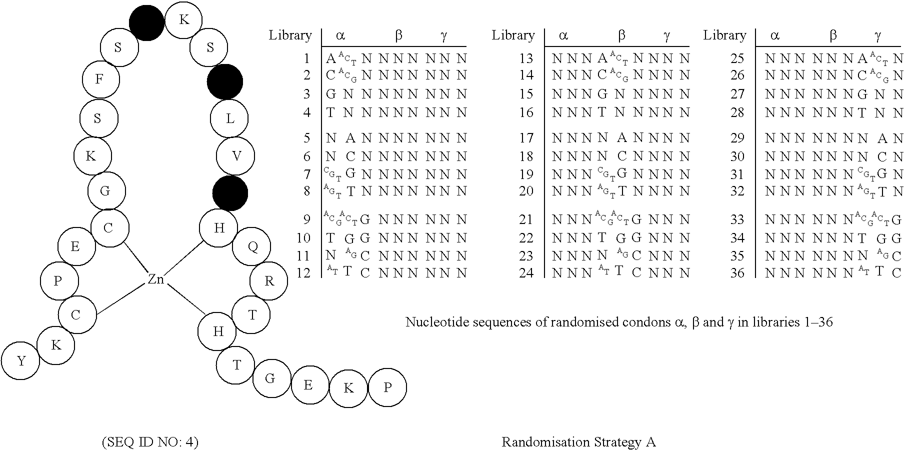

All 36 gene libraries are expressed to generate zinc finger libraries. These zinc finger libraries are then incubated with a polynucleotide of interest, in such a way as to identify one library from each group of four that binds most strongly to the polynucleotide. For example, each library may be placed in an individual well of a microtitre plate and there incubated with the same trinucleotide.

Consider the controlled randomisation of residue α. Because in any one group of 4 libraries each amino acid is encoded only once, each amino acid, as residue α, will occur in only three of the twelve libraries:

| Library | Lys | Asn | Thr | Ile | Met | Gln | His | Pro | Glu | Asp | Ala | Gly | Val | Tyr | Cys | Trp | Phe | Ser | Arg | Leu |
|---|---|---|---|---|---|---|---|---|---|---|---|---|---|---|---|---|---|---|---|---|
| 1 | { | { | { | { | { | — | — | — | — | — | — | — | — | — | — | — | — | — | — | — |
| 2 | — | — | — | — | — | { | { | { | — | — | — | — | — | — | — | — | — | — | { | — |
| 3 | — | — | — | — | — | — | — | — | { | { | { | { | { | — | — | — | — | — | — | — |
| 4 | — | — | — | — | — | — | — | — | — | — | — | — | — | { | { | { | { | { | — | { |
| 5 | { | { | — | — | — | { | { | — | { | { | — | — | — | { | — | — | — | — | — | — |
| 6 | — | — | { | — | — | — | — | { | — | — | { | — | — | — | — | — | — | { | — | — |
| 7 | — | — | — | — | — | — | — | — | — | — | — | { | — | — | { | { | — | — | { | — |
| 8 | — | — | — | { | { | — | — | — | — | — | — | — | { | — | — | — | { | — | — | { |
| 9 | { | — | { | — | { | { | — | { | { | — | { | — | { | — | — | — | — | — | — | { |
| 10 | — | — | — | — | — | — | — | — | — | — | — | — | — | — | — | { | — | — | — | — |
| 11 | — | { | — | — | — | — | { | — | — | { | — | { | — | { | { | — | — | { | { | — |
| 12 | — | — | — | { | — | — | — | — | — | — | — | — | — | — | — | — | { | — | — | — |

Key:
{: Specified amino acid is present in this library, at position α.
—: Specified amino acid is not present in this library, at position α.

Presence/absence of an amino acid at position a within any given library is a direct result of the controlled randomisation and the genetic code.

This may now be applied to the assay. Consider that libraries 1-12 only are screened with the trinucleotide ATG and that in order for a zinc finger to bind ATG, residue a must be Lys (lysine). An assay of libraries 1-12 is performed:

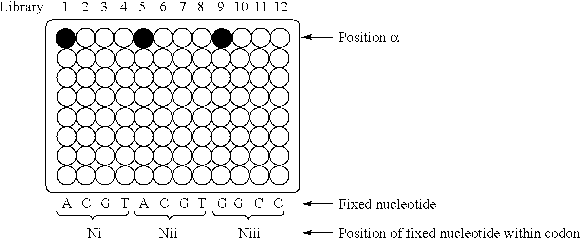

Only libraries 1, 5 and 9 contain lysine as residue α, therefore only these libraries can emit light. None of the other libraries can emit light, because none of them specify lysine as residue α. However, this is not the limit of our knowledge. We know the identity of the fixed nucleotide within each library. Moreover, we can read this off directly from the microtitre plate. In this case, the order of fixed nucleotides is AAG.

Thus, simply from the unique combination of libraries which emit light, we know the genetic code for the amino acid required as residue α. In this case, the essential fixed nucleotides are AAG, which specifies lysine. We have now linked the genetic code directly to the physical properties of a protein.

This principle may be applied to all 36 libraries. In so doing, the genetic codes and thus required identities of all three residues α, β and γ will be determined:

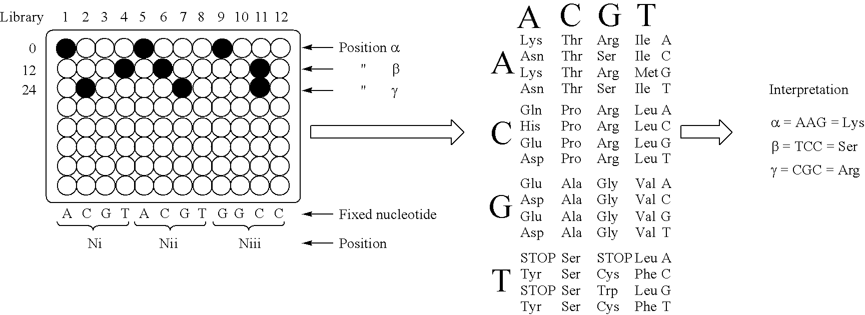

This is possible, because in libraries 1-12, residues β and γ are fully randomised. Therefore, in each of libraries 1-12 Ser and Arg are present as residues β and γ within the mixture.

Similarly, when controlled randomisation is applied to residue β (libraries 13-24) residues α and γ are fully randomised and when controlled randomisation is applied to residue γ, residues α, β are fully randomised.

By screening the 36 libraries with each of the 64 trinucleotides, an optimum zinc finger will be found for each trinucleotide. Thus the result is therefore the solution of the zinc finger code whereby DNA binding proteins may now be designed at will.

Should more than three libraries within a given set of twelve produce a signal, then the plates may be washed to remove signals resulting from weak interactions. An end point to the assay has been reached when just three libraries per set of twelve generate a signal.

The above strategy generates libraries of genes which when expressed, yield protein libraries in which two positions are fully randomised and one position has controlled randomisation. In practice, this leads to libraries with between 400 (e.g. library 10) and 3600 (eg. library 9) constituent proteins. These numbers are calculated as follows:

$$\begin{matrix} Number of library constituents & = \begin{matrix}multiplication of number of \\ possibilities at each position \\ of randomisation\end{matrix} \\ eg . library 1 \text{:} & = position α \times position β \times position γ \\ & 5 \times 20 \times 20 \\ & = 2000 consultants ( proteins )\end{matrix}$$

However, these small libraries result from the degeneracy of the genetic code. In practice, the gene libraries which encode the proteins, randomised as above, will be far larger. For example, again consider library 1:

| Codon | α | β | γ | |
|---|---|---|---|---|
| Sequence | A [symbol] N | N N N | N N N | |
| Numbers | 1 × 3 × 4 × | 4 × 4 × 4 × | 4 × 4 × 4 = | 49152 |
| | | | | constituents |
| | | | | (genes) |

The generation of such libraries should not be problematic technically, since libraries far larger than these exist already (eg. Choo and Klug, 1994, PNAS 91, 11163-7). However, it may it may prove beneficial to reduce the gene library sizes to those of the protein libraries. Potential benefits include:
greater likelihood of full representation within each library (all constituent proteins encoded);
even representation of each constituent (an equal amount of each constituent protein within a given library);
consistent optimum codon usage (to maximise expression).

These attributes are desirable because of the degeneracy of the genetic code. Again consider library 1. Within this library, position 13 is encoded by NNN. When expressed therefore, residue β is 6 times more likely to be serine than it is to be methionine, because serine is encoded six times within NNN for each encoding of methionine.

Such bias within libraries may have an adverse effect on the results of the assay. Any detrimental effect is predicted to be minor—it should occur only if two proteins have similar binding affinities with a given DNA sequence. However, such an eventuality is possible: consider that two zinc fingers with positions α=Arg, β=Ser, γ=Lys and α=Arg, β=Met, γ=Lys bind similarly to a given sequence of DNA, with α=Arg, β=Met, γ=Lys being the optimally binding zinc finger protein. During the assay, the effective concentration of the protein containing serine at position 1 would be greater than that of the protein containing methionine. Thus, the serine-containing protein might give a stronger signal even though it is not the optimum zinc finger for that DNA sequence.

It may therefore be preferred to substitute the codon MAX for positions of full randomisation (previously NNN), where MAX is a mixture containing only the following codons:

AAA, AAC, ACC, AGC, ATG, ATT, CAG, CAT, CCG, CGC, CTG, GAA, GAT, GCG, GGC, GTG, TAT, TGG, TGC, TTT.

These codons represents those most favoured by E. coli for each amino acid (Nakamura et al., (1997), Nucleic Acids Research, 25, 244-245).

In order to employ these codons in controlled randomisation, a new division of the codons into sets of 12 libraries is required, as outlined in randomisation strategy B.

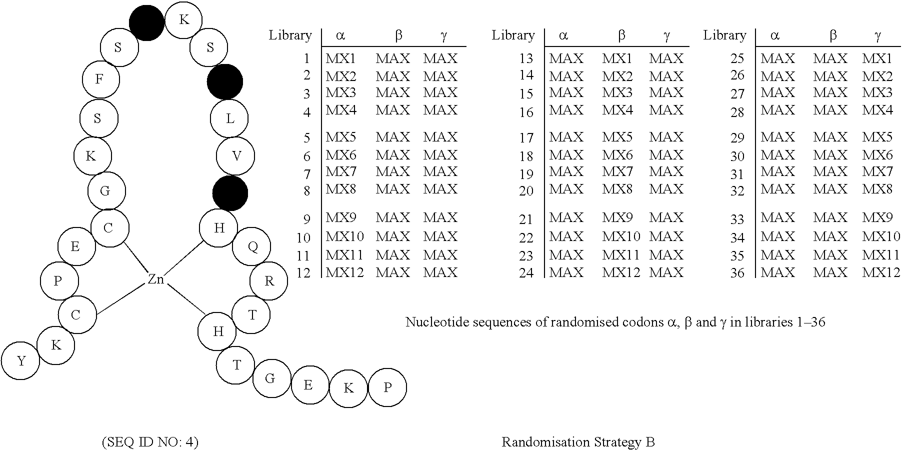

where mixes 1 to 12 are as detailed in Table 2:

| | | | | | | | | | | | | |
|---|---|---|---|---|---|---|---|---|---|---|---|---|
| Mix | 1 | 2 | 3 | 4 | 5 | 6 | 7 | 8 | 9 | 10 | 11 | 12 |
| Codons | AAA | CAG | GAA | TAT | AAA | ACC | AGC | ATG | AAA | AAC | ATG | ATT |
| | AAC | CAT | GAT | TGC | AAC | CCG | CGC | ATT | GAA | ACC | CAG | CAT |
| | ACC | CCG | GCG | TGG | CAG | GCG | GGC | CTG | | AGC | CCG | GAT |
| | AGC | CGC | GGC | TTT | CAT | | TGC | GTG | | CGC | CTG | TAT |
| | ATG | CTG | GTG | | GAA | | TGG | TTT | | GGC | GCG | TTT |
| | ATT | | | | GAT | | | | | TGC | GTG | |
| | | | | | TAT | | | | | | TGG | |
| Fixed | A | C | G | T | A | C | G | T | A | C | G | T |
| nucleotide | | | | | | | | | | | | |

| | | | |
|---|---|---|---|
| Position | Ni | Nii | Niii |

Consider the controlled randomisation of position a (libraries 1-12). When expressed, position a will be represented as follows in each library, while positions β and γ are fully randomised.

| Library | Lys | Asn | Thr | Ile | Met | Gln | His | Pro | Glu | Asp | Ala | Gly | Val | Tyr | Cys | Trp | Phe | Ser | Arg | Leu |
|---|---|---|---|---|---|---|---|---|---|---|---|---|---|---|---|---|---|---|---|---|
| 1 | { | { | { | { | { | — | — | — | — | — | — | — | — | — | — | — | — | { | — | — |
| 2 | — | — | — | — | — | { | { | { | — | — | — | — | — | — | — | — | — | — | { | { |
| 3 | — | — | — | — | — | — | — | — | { | { | { | { | { | — | — | — | — | — | — | — |
| 4 | — | — | — | — | — | — | — | — | — | — | — | — | — | { | { | { | { | — | — | — |
| 5 | { | { | — | — | — | { | { | — | { | { | — | — | — | { | — | — | — | — | — | — |
| 6 | — | — | { | — | — | — | — | { | — | — | { | — | — | — | — | — | — | — | — | — |
| 7 | — | — | — | — | — | — | — | — | — | — | — | { | — | — | { | { | — | { | { | — |
| 8 | — | — | — | { | { | — | — | — | — | — | — | — | { | — | — | — | { | — | — | { |
| 9 | { | — | — | — | — | — | — | — | { | — | — | — | — | — | — | — | — | — | — | — |
| 10 | — | { | { | — | — | — | — | — | — | — | — | { | — | — | { | — | — | { | { | — |
| 11 | — | — | — | — | { | { | — | { | — | — | { | — | { | — | — | { | — | — | — | { |
| 12 | — | — | — | { | — | — | { | — | — | { | — | — | — | { | — | — | { | — | — | — |

The changes in controlled randomisation will affect the library numbers which produce q signal and therefore the interpretation of the assay results. However, the principles of controlled randomisation and the mechanism of assay interpretation remain unchanged. Using randomisation strategy B, the example illustrated above is reiterated:

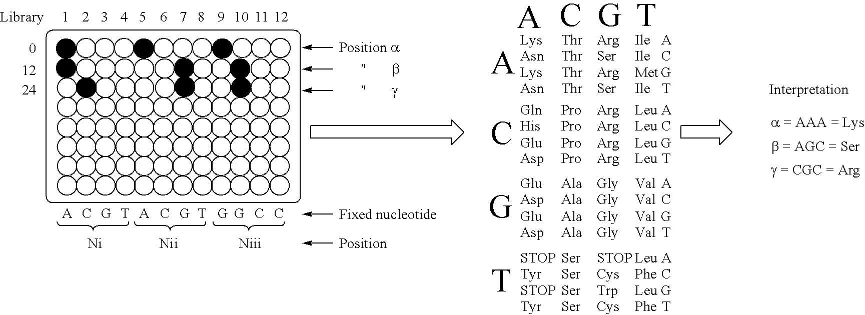

Note the different fixed nucleotides in libraries 9-12 and that different libraries now light up. The end result: α=Lys, β=Ser, γ=Arg is the same, however.

Randomisation strategy A is in principle, the easier strategy to implement technically. However, strategy B is preferred. Gene libraries of much smaller size are required. Although construction of these highly-controlled libraries is technically demanding, it is much more likely that the libraries encode all required proteins and moreover that those proteins are encoded in similar proportions, so removing potential difficulties in the SPA library assays.

Construction of these gene libraries may be achieved by cloning oligonucleotide cassettes between two appropriately positioned restriction sites which flank positions α and γ. Construction of the oligonucleotide cassettes requires a set of sixty-one oligonucleotides comprising one fully-randomised “template” oligonucleotide and three pools of selection oligonucleotides. The template oligonucleotide is of sequence

3′-----------------NNN-----------NNN------------NNN---------5′

where [symbol] represents the invariant DNA and NNN the positions of randomisation within the non-coding strand of the gene. The intervening sequences [symbol] are conveniently between 3 and 21 bases in length.

The pools of selection oligonucleotides contain twenty individual oligonucleotides of sequence

Lys: 5′-------------AAA------3′
Asn: 5′-------------AAC------3′
Thr: 5′-------------ACC------3′
Ser: 5′-------------AGC------3′
Met: 5′-------------ATG------3′
Ile: 5′-------------ATT------3′
Gln: 5′-------------CAG------3′
His: 5′-------------CAT------3′
Pro: 5′-------------CCG------3′
Arg: 5′-------------CGC------3′
Leu: 5′-------------CTG------3′
Glu: 5′-------------GAA------3′
Asp: 5′-------------GAT------3′
Ala: 5′-------------GCG------3′
Gly: 5′-------------GGC------3′
Val: 5′-------------GTG------3′
Tyr: 5′-------------TAT------3′
Trp: 5′-------------TGG------3′
Cys: 5′-------------TGC------3′
Phe: 5′-------------TTT------3′

where the sequence [symbol] is of suitable length and base sequence to base pair with the non-variant regions of the template and the defined codon corresponds to one of those comprising the “MAX” set of codons (defined herein at page 18, line 5). The defined codon corresponds to a position of randomisation and must be either at or near to one end of the oligonucleotide. A complete selection pool represents a set of twenty such oligonucleotides, in order that all codons contained within “MAX” are represented and all twenty amino acids are encoded.

The invention enables fully randomised libraries, positionally fixed libraries and individual genes to be constructed. Oligonucleotides encoding the required amino acid at each position of randomisation would be taken from each selection pool. For example, if full randomisation is required at a given position, then all 20 selection oligonucleotides would be taken. If positional fixing were required, then all oligonucleotides where the “MAX” codon begins with A (for example) would be taken. If a single amino acid were required at the position of randomisation, the single selection oligonucleotide corresponding to that amino acid would be taken.

Construction of a Single Zinc Finger Gene Encoding α=Lys, β=Ser, γ=Arg

The selection oligonucleotides β-Ser and γ-Arg are treated with T4 polynucleotide kinase and ATP in order to attach 5′ phosphate groups and so enable them to participate in ligation reactions. These two oligonucleotides, together with the selection oligonucleotide α-Lys and the template oligonucleotide are combined, heated to 90° C. and allowed to cool slowly to room temperature, in order to allow complementary sequences of DNA to base pair as shown below: 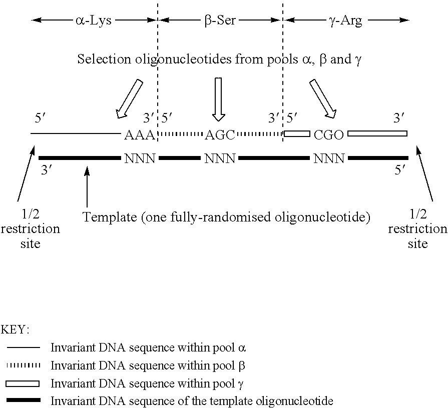
The resulting oligonucleotide cassette is then inserted into the appropriate restriction sites in the zinc finger gene, so generating the zinc finger gene α=Lys, β=Ser, γ=Arg. None of the other sequences contained in the template oligonucleotide are cloned, since only the double stranded DNA cassette will be ligated into the parental gene. Selection from the template oligonucleotide is thus achieved by addition of the three selection oligonucleotides.
Construction of Zinc Finger Library 1

The selection oligonucleotides β-MAX and γ-MAX (where MAX=an entire selection pool) are treated with T4 polynucleotide kinase and ATP in order to attach 5′ phosphate groups and so enable them to participate in ligation reactions. These two oligonucleotide pools, together with the selection oligonucleotide α-MIX 1 where MIX 1 is the following mixture of oligonucleotides:

α-Lys: 5′-------------AAA------3′
α-Asn: 5′-------------AAC------3′
α-Thr: 5′-------------ACC------3′
α-Ser: 5′-------------AGC------3′
α-Met: 5′-------------ATG------3′
α-Ile: 5′-------------ATT------3′

and the template oligonucleotide are combined, heated to 90° C. and allowed to cool slowly to room temperature, in order to allow complementary sequences of DNA to base pair as above.

The resulting mixture of oligonucleotide cassettes is then inserted into the appropriate restriction sites in the zinc finger gene, so generating the zinc finger library 1. None of the other sequences contained in the template oligonucleotide are cloned, since only the double stranded DNA cassettes will be ligated into the parental gene. Selection from the template oligonucleotide is thus achieved by addition of the three pools of selection oligonucleotides. Note that the number of genes exactly matches the number of encoded proteins and that no truncated proteins should result, since “MAX” contains no termination codons.

Generalised Application to Randomised Peptides

The above technique may also be used to generate genes encoding fully randomised peptides, without intervening conserved gene sequences. Again, the number of genes will exactly match the number of encoded peptides. In the case of a fully randomised peptide library without positional fixing, just 21 oligonucleotides are required: a fully-randomised template oligonucleotide of the desired length and a set of the twenty “MAX” trinucleotides. Annealing between the set of “MAX” trinucleotides and the template will generate cassettes encoding all possible peptides, dependent on complete representation within the template oligonucleotide, which will decrease with oligonucleotide length.

Positionally fixed, random peptides may be made similarly, although a set of twelve templates will be required for each codon. Here, for a given codon, the non-coding template strand will be fixed alternatively as T, G, C and A at each nucleotide and the “MAX” trinucleotides annealed as above.

a) The above strategies A and B involve designing sets of libraries of genes which in turn may be expressed to generate corresponding libraries of proteins.

The method of the invention involves incubating a set of libraries of proteins with a specific binding partner, observing specific binding interactions with certain libraries of the set, and using the observations to identify a protein which interacts with the specific binding partner. Although other assay techniques are possible, this method is preferably performed using scintillation proximity assay (SPA) technology. Briefly this technology involves providing a support which comprises a scintillant which emits light when subjected to electrons (e.g. β particles) or other forms of radiation resulting from decomposition of a radioisotope. The support may be massive, e.g. the base of each well of a microtitre plate, or may be particulate. One assay reagent is immobilised on the support. Another assay reagent is radiolabelled and is partitioned between two fractions, one bound to the support and the other free in solution. The relative size of the two fractions is arranged to be related to the presence or the concentration of an analyte of interest. The radioisotope is chosen such that reagent bound to the support causes the scintillant in the support to emit light, while reagent free in solution does not (on account of the short mean free path of the radiation) significantly affect the scintillant substance.

Various assay formats are possible. For example, each library of a set of libraries can be immobilised in an individual well, either of a standard microtitre plate or of a scintillant containing microtitre plate. A specific binding partner of the proteins is labelled and introduced into each well. Labels can be radiometric, luminescent, for example fluorescent or may be an enzyme. Where radiometric of luminescent labels are used, a specific binding interaction can be investigated in real time. Where enzyme labels are used the interaction can be investigated upon addition of the appropriate reagents needed to generate a signal. Where several wells emit light, repeated washing can be used to remove weakly interacting species until the specific binding partner remains bound only in a single well. This ability to identify a single library (as opposed to a small pool of libraries) that bind most strongly to any particular specific binding partner, is a valuable feature, and an advance on assay techniques used previously for similar purposes.

Alternatively, the specific binding partner can be immobilised in each well of the SPA microtitre plate. Each protein library is radiolabelled and introduced into a different well of the plate for interaction with the specific binding partner. Alternative assay formats, in which neither the protein library nor its specific binding partner, but rather a third reagent is radiolabelled, are well known in the art.

Techniques for immobilising protein or other assay reagents on SPA surfaces in forms suitable for taking part in SPA assays, are well known in the art. Development of suitable techniques should not amount to more than the routine optimisation ordinarily required for assays of this kind. Detection of interactions by non-radioactive assay and imaging techniques such as luminescent, for example fluorescent detection or colorimetric detection of interactions between, for example, biotin linked and streptavidin linked partners are also envisaged.

Most zinc finger proteins form the DNA recognition module of transcription factors, which serve to switch genes on or off. Already, several examples exist where novel transcription factors have been engineered, by changing their zinc fingers (Choo et al (1994), Nature 372, 642-5). Similarly, zinc fingers have been linked to restriction endonuclease cleavage domains, to generate novel restriction endonucleases (e.g. Kim et al (1996), PNAS 93, 1156-60). The application of zinc fingers is almost limitless—when ever a need arises to link something to a specific sequence of DNA, it can be met with a series of zinc fingers. However, in order to design DNA-binding proteins at will, there must be available one zinc finger for each trinucleotide. This invention provides enabling technology to achieve that object.

### EXAMPLES

The present examples are provided for illustrative purposes only and illustrate certain embodiments of the instant invention. They are not intended to be illustrative of all embodiments of the present invention as recited in the claims.

The example involves a single protein, comprising three zinc fingers. Controlled randomisation is applied only to the central zinc finger. The two outer zinc fingers are present simply to ensure correct registry with the target DNA sequence and to increase overall binding strength (Choo and Klug, (1994) PNAS 01, 11163-67; Berg (1997) Nature Biotech. 15, 323).

The work is divided into four stages: gene synthesis, gene expression, radiometric and calorimetric assay formats, assay results and proof of principle.

Gene Synthesis:

A gene was designed and synthesised to encode the protein (SEQ ID NO: 1)

T G E K P Y K CP E CG K S F S [symbol] K S [symbol] L V [symbol] H Q R T H
T G E K P Y K CP E CG K S F S [symbol] K S [symbol] L V [symbol] H Q R T H
T G F K P Y K CP F CG K S F S [symbol] K S [symbol] L V [symbol] H Q R T H.

KEY:
X linker residues
X zinc co-ordinating residues
X DNA-contacting residues (α, β and γ) (positions −1, +3 and +6)

This protein corresponds to three repeats of Berg's consensus zinc finger sequence (Krizek et al., (1991) JACS 113, 4518-23), with DNA-contacting residues from the first zinc finger of transcription factor Sp1 (Berg (1992) PNAS 89, 11109-10; Shi and Berg, (1995) Chem & Biol. 2, 83-89). Each zinc finger sequence is preceded by a Kruppel-type linker peptide (Choo and Klug (1993) NAR 21, 3341-6). By analogy to previous precedent (Shi and Berg, 1995), the three repeats of this novel zinc finger peptide are expected to bind to the dsDNA sequence 5′-GGG GGG GGG-3′.

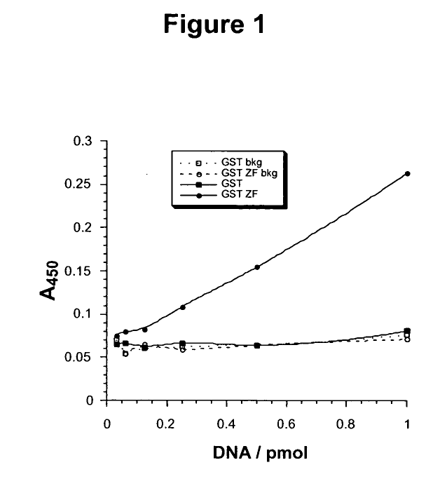

To maximise gene expression, on converting the sequence into DNA, E. coli codon preference was employed (Wada et al. (1992) NAR20 sup., 2111-8). Wherever possible, first preference codons were used. However, in some instances, second preference codons were also employed. These limited sequence repetition within the gene, necessary to prevent potential intragenic recombination events, which would be deleterious to ensuing experiments. In practice, a maximum repeat length of 8 base pairs was mostly achieved. Use of second preference codons also allowed the incorporation of restriction enzyme sites within the gene. The final gene sequence, restriction sites and codon usage are illustrated in FIG. 1.

Gene Expression

In the current assay format, the zinc finger gene is fused to the glutathione-S-transferase gene in the vector pGEX2TK (Amersham Pharmacia Biotech). Expression of this construct leads to a 36.5 kD protein comprising GST at the amino terminus and the zinc finger protein at the carboxyl terminus. Gene expression is performed in E. coli BL21 cells according to manufacturer's instructions. The resulting fusion protein is then purified using glutathione-Sepharose (Amersham Pharmacia Biotech) according to manufacturer's instructions. Use of the pGEX2TK vector allows for the subsequent radiolabelling of the protein if required.

Assay Formats for Assessing Zinc Finger—DNA Interactions

Direct Attachment of GST Fusion Protein to Microtitre Plates, Followed by Colorimetric Detection of Biotinylated DNA (Assay Format 1)

GST or GST ZF protein (4 pmoles per well) was immobilised in microtitre wells in carbonate buffer, pH 9.2, for 18 hrs. The plates were washed three times in TBS-Tween (0.3% Tween) and then blocked in the same buffer for 3 hrs. After washing, 2-fold serial dilutions of DNA were added to each well. The protein and DNA were incubated together for 2 hrs at room temperature, and the wells were then washed 3 times in TBS-Tween. As negative controls, experiments were performed in the absence of DNA, to assess binding of GST/GST ZF proteins by the streptavidin conjugate. Bound DNA was detected by adding streptavidin/peroxidase conjugate, which was removed by 3 washes in TBS. Finally, the conjugate was detected colorimetrically according to manufacturer's instructions. All reactions were performed in duplicate. FIG. 1 demonstrates that interaction between the zinc finger protein and its target DNA sequence may be assessed using this assay format. In FIGS. 1, 2 and 3, the legend ‘bkg’ denotes background detection levels.

Direct Attachment of GST Fusion Protein to Microtitre Plates, Followed by Scintillation-based Detection of Radiolabelled DNA (Assay Format 2)

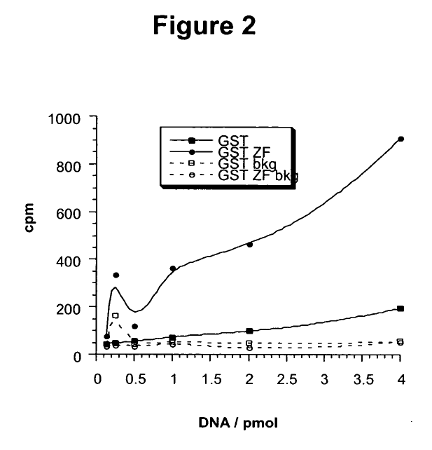

GST or GST ZF protein (4 pmoles per well) was immobilised in microtitre wells in carbonate buffer, pH 9.2, for 18 hrs. The plates were washed three times in TBS-Tween (0.3% Tween) and then blocked in the same buffer for 3 hrs. After washing, 2-fold serial dilutions of radiolabelled DNA were added to each well. The protein and DNA were incubated together for 2 hrs at room temp, and the wells were then washed 3 times in TBS-Tween. Bound DNA was detected by scintillation counting. All reactions were performed in duplicate. FIG. 2 demonstrates that interaction between the zinc finger protein and its target DNA sequence may be assessed using this assay format.

Antibody-based Attachment of GST Fusion Protein to Microtitre Plates, Followed by Scintillation-based Detection of Radiolabelled DNA (Assay Format 3)

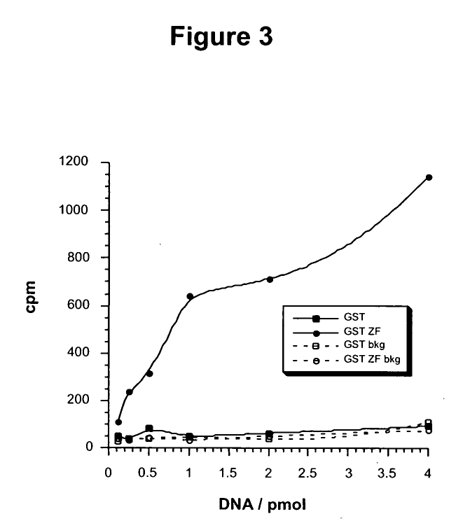

One μg of protein A was attached to the surface of each microtitre well in carbonate buffer, pH 9.2, for 18 hrs. The plates were washed three times in TBS-BSA (2% BSA) and then blocked in the same buffer for 3 hrs. Anti-GST antibody (1 μg) was added to each well in the same buffer and incubated at room temperature with rocking, for 1 hr. The plates were washed 3 times in TBS-BSA and then incubated for 1 hr with 4 pmoles GST/GST ZF protein per well. After washing away unbound protein, the plates were incubated for 2 hrs at room temp with 2-fold serial dilutions of radiolabelled DNA. Unbound DNA was removed by 3 washes in TBS-BSA. As negative controls, experiments were performed in the absence of antibody, to assess any binding of radiolabelled DNA by protein A. All reactions containing GST/GST ZF were performed in duplicate. FIG. 3 demonstrates that interaction between the zinc finger protein and its target DNA sequence may be assessed using this assay format.

Conclusion

Three adsorption-based assay formats have been developed. All assay formats demonstrate interaction between the protein and its DNA target sequence. In each case, the protein is immobilised and the DNA is in solution. Labelled DNA is bound by the immobilised protein and then detected according to the nature of the label. Radiolabelled DNA is detected using scintillation-based methods or appropriate imaging technology. Non-radiometrically labelled DNA is detected using colorimetric techniques and a spectrophotometer. The assay formats are also applicable to fluorescently labelled DNA, where imaging technology would be used to detect the bound DNA.

Those skilled in the art, having the benefit of the teachings of the present invention as set forth above, can effect numerous modifications thereto. These modifications are to be construed as being encompassed within the scope of the present invention as set forth in the appended claims.

1. A set of libraries of genes which code for proteins which are capable of specific binding interactions with a specific binding partner by amino acid residues at at least two specified positions including a first specified position and at least one other specified position, which set of libraries comprises:
a) 6 to 20 libraries in which each library has a triplet that codes for at least one but less than 20 amino acids at said first specified position, and is randomised at the or each triplet coding for the said at least one other specified position, the arrangement being such that interactions of the proteins coded for by the said 6 to 20 libraries with a specific binding partner identifies a triplet that codes for an amino acid at the said first specified position that takes part in the specific binding interaction, and
b) 6 to 20 libraries in each of which libraries said first specified position is randomized and a different one of said at least one other specified positions has a triplet that codes for at least one but less than 20 amino acids.

2. The set of libraries of genes of claim 1, which set of libraries comprises:
a) 12 libraries in which each library has a triplet that codes for one or several but less than 20 amino acids at the said first determined position, the triplets being as shown in Table 1 or Table 2, and
b) 12 libraries of corresponding design for each of the said one or more other determined positions.

3. The set of libraries of genes of claim 1, wherein the genes code for zinc fingers.

4. The set of libraries of genes of claim 3, which set comprises 36 libraries in three groups of 12 libraries which code for amino acids at the −1 and +3 and +6 positions respectively.

5. The set of libraries of genes of claim 3, wherein each gene codes for a protein comprising three zinc fingers.

6. The set of libraries of genes of claim 5, wherein each gene codes for a protein having the sequence (SEQ ID NO: 2)
T G E K P Y K C P E C G K S F S X K S X L V X H Q R T H
T G E K P Y K C P E C G K S F S X K S X L V X H Q R T H
T G E K P Y K C P E C G K S F S X K S X L V X H Q R T H
where X is any amino acid.

7. A set of libraries of proteins, which proteins are capable of specific binding interactions with a specified binding partner by amino acid residues at at least one specified position including a first specified position and at least one other specified position, which set of libraries comprises:
a) 6 to 20 libraries in which each library has at least one several but less than 20 amino acid residues at the said first specified position and is randomised at the said at least one other specified position, the arrangement being such that interaction of the 6 to 20 libraries with a specific binding partner identifies an amino acid residue at the said first specified position that takes part in the specific binding interaction, and
b) 6 to 20 libraries in each of which libraries said first specified position is randomized and a different amino acid is present at at least one other specified position.

8. The set of libraries of proteins of claim 7, which set of libraries comprises:
a) 20 libraries in which each library has one specified amino acid residue at the said first specified position and is randomised at the said one or more other specified positions, and
b) 20 libraries of corresponding design for each of the said one or more other specified positions.

9. The set of libraries of proteins of claim 7, wherein the proteins are zinc fingers.

10. The set of libraries of proteins of claim 7, which set comprises 60 libraries in three groups of 20 libraries with specified amino acids at the −1 and +3 and +6 positions respectively.

11. The set of libraries of proteins of claim 9, wherein each protein comprises three zinc fingers.

12. The set of libraries of proteins of claim 11, wherein each protein as the sequence (SEQ ID NO: 2)
T G E K P Y K C P E C G K S F S X K S X L V X H Q R T H
T G E K P Y K C P E C G K S F S X K S X L V X H Q R T H
T G E K P Y K C P E C G K S F S X K S X L V X H Q R T H
where X is any amino acid.

13. A set of libraries of genes which code for the set of libraries of proteins of claim 7.

14-24. (canceled)

25. A protein having the sequence (SEQ ID NO: 1)
T G E K P Y K C P E C G K S F S [symbol] K S [symbol] L V [symbol] H Q R T H
T G E K P Y K C P E C G K S F S [symbol] K S [symbol] L V [symbol] H Q R T H
T G E K P Y K C P E C G K S F S [symbol] K S [symbol] L V [symbol] H Q R T H.

26. A gene which codes for the protein of claim 25.

27. A method of constructing randomised gene libraries in which the number of genes is the same as the number of encoded proteins and which contain no termination codons at the predetermined positions of randomisation, the method comprising the steps of:
a) providing a template oligonucleotide which is fully randomised at predetermined codon positions;
b) providing a pool of selection oligonucleotides for each predetermined codon position, wherein each member of said pool contains a different codon selected from the group consisting of:
AAA, AAC, ACC, AGC, ATG, ATT, CAG, CAT, CCG, CGC, CTG, GAA, GAT, GCG, GGC, GTG, TAT, TGG, TGC, TTT
at the predetermined codon position;
c) selecting one or more selection oligonucleotides from each pool in order to encode the required gene or library;
d) allowing the ligated selected oligonucleotides from each pool to hybridise with the template oligonucleotide;
e) forming one or more constructs by ligating the hybridised selection oligonucleotides together;
f) removing a region from a gene of interest corresponding to the hybridised product from step e);
g) forming a gene library or genes by ligating the products from step e) into the said gene of interest wherein the said gene of interest is contained within a suitable expression vector.

28. A method of producing proteins encoded by the randomized gene libraries of claim 27 comprising the steps of:
a) transforming a suitable host cell with the gene or gene library of claim 27 construct;
b) expressing the genes to form proteins;
c) purifying the proteins.


SEQUENCE LISTING (4 sequences)

SEQ ID NO: 1 - protein, 28 aa, ARTIFICIAL SEQUENCE
  SYNTHETIC PEPTIDE CONSTRUCT
TGEKPYKCPECGKSFSKKSHLVAHQRTH

SEQ ID NO: 2 - protein, 28 aa, ARTIFICIAL SEQUENCE
  SYNTHETIC PEPTIDE CONSTRUCT
TGEKPYKCPECGKSFSXKSXLVXHQRTH

SEQ ID NO: 3 - protein, 28 aa, ARTIFICIAL SEQUENCE
  ZINC FINGER MOTIF
XXCXXCXXXFXXXXXLXXHXXXHXXXXX

SEQ ID NO: 4 - protein, 28 aa, ARTIFICIAL SEQUENCE
  ZINC FINGER MOTIF
YKCPECGKSFSXKSXLVXHQRTHTGEKP